(19) United States
(12) Patent Application Publication
(10) Pub. No.: US 2016/0217486 A1
(43) Pub. Date: Jul. 28, 2016

(54) AUTOMATIC ADJUSTMENT OF LOYALTY AWARDS IN PERSONALIZED DIGITAL MEDIA BASED ON CHOSEN MEDIA PLATFORM

(71) Applicant: Autography LLC, St. Petersburg, FL (US)

(72) Inventors: Thomas J. Waters, St. Petersburg, FL (US); Robert N. Barrett, St. Petersburg, FL (US)

(21) Appl. No.: 15/006,378

(22) Filed: Jan. 26, 2016

Related U.S. Application Data
(60) Provisional application No. 62/107,747, filed on Jan. 26, 2015.

(51) Int. Cl. G06Q 30/02; G06Q 50/00

(52) U.S. Cl. CPC G06Q 30/0226; G06Q 50/01; G06Q 30/0224

(57) ABSTRACT

Disclosed are systems and methods for selectively providing electronic rewards to a user based on personalized digital media shared on social media site. The personalized digital media may include, for example, an electronic autograph, an electronic written message, an electronic video message, or a combination thereof provided by an author, a celebrity, an athlete, a musician, or a combination thereof having a unique identifier. In certain aspects, the unique identifier may be used to determine a user's electronic social media habits to further target user(s).

### CROSS-REFERENCE TO RELATED APPLICATION

This application claims priority to U.S. Provisional Patent Application No. 62/107,747 filed on Jan. 26, 2015, the contents of which are incorporated by reference herein.

### TECHNICAL FIELD

The present invention relates generally to the field of digital media and electronic rewards, and more particularly, to systems and methods for selectively providing electronic rewards to a user based on personalized digital media shared on one or more social media site(s).

### BACKGROUND

Fragmentation of the entertainment business has been dramatic, forcing legacy media firms to adapt new business models. Established retailers have acquired or are starting their own digital services to meet consumer demand. Many retailers are now simply retooling their business models to work directly within or on top of popular social media sites.

But social media sites are not equal. Most sites are designed for, or become extremely popular with a select demographic. For example, Snapchat is popular with a younger audience, while Pinterest is preferred by an older demographic. Also, men comprise the majority of Linkedln accounts, while women are the majority account holders and posters on Facebook.

According to a social media study by Business Insider, (Sep. 2, 2014), social media networks have very specific socio-demographic majorities. These include:
Facebook—mainly female, still #1 social network
Instagram—judged most important social media site by teenagers
Linkedln—most popular among 30-49 year olds
YouTube—reaches more 18-34 year old adults, more than any cable tv channel

A lot of entertainment is now being streamed rather than consumed in person. Entertainers receive requests to connect with fans over the Internet, but they may not know who those fans are. Gender, age, and nationality are not immediately evident when a request for memorabilia is received. Is ‘Pat’ a man or a woman? Is ‘Kim’ American or Korean? Digital audiences are increasingly global, so quickly and efficiently identifying the demographics of fans is increasingly difficult. Methods and systems to identify, store, and analyze fan demographics are still in their infancy. Entertainers can't always predict a fan's social media preferences, and social media penetration varies widely from country to country. While sites like Facebook enjoy a worldwide user base, small specialty sites like Blip.no require a Norwegian phone number to register—intentionally limiting the scope of potential members. But the postings by and from members can include media acquired from anywhere in the world.

Currently, many of the above mentioned social media sites lack the capability of providing personalized media. For example, a fan's follower on Twitter, Facebook, or Linkedln lacks the capability of efficiently providing a service for requesting personalized media, and for the existing services, these services lack any capabilities of identifying where a fan falls within the socio-economic spectrum, which can be crucial to aid in further targeting and providing additional services to these fans. Thus, a service is needed that aids in identifying where fans fall within the socio-economic spectrum, while concurrently provide an incentive and rewards program in which their digital memorabilia can adjust based on the specific social media platform a fan posts it to.

### SUMMARY OF THE INVENTION

Disclosed are systems and methods for selectively providing electronic rewards to a user based on personalized digital media shared on social media site. The personalized digital media may include, for example, an electronic autograph, an electronic written message, an electronic video message, or a combination thereof provided by an author, a celebrity, an athlete, a musician, or a combination thereof having a unique identifier. In certain aspects, the unique identifier may be used to determine a user's electronic social media habits to further target user(s).

In certain aspects, disclosed is a method of providing electronic rewards to a user based on identifying personalized digital media communicated to a social media site, the method including: (a) communicating a request from a user's media device to a database having stored personalized digital media; (b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site; (c) storing the communicated requested personalized digital media of step (b) on the user's media device; (d) accessing the electronic social media site with the user's media device; (e) communicating the personalized digital media of step (c) stored on the user's media device from the user's media device to the electronic social media site and sharing the personalized digital media on the electronic social media site such that other users of the social media site can view the personalized digital media; (f) after step (e), communicating in to the user's media device a reward for sharing the personalized digital media on the electronic social media site and also communicating to the database the unique identifier identifying the personalized digital media; (g) after step (f), identifying, by the database, the personalized digital media of step (f) by the unique identifier and the electronic media site from which the personalized digital media of step (f) was communicated; and (h) determining a user's electronic social media habits by comparing the personalized digital media of step (g) with demographic information associated with the user's media device including at least one of age, education level, income, gender or any combination thereof. In certain aspects, step (f) may be performed in real time and communicate the reward to the user's device either concurrently or sequentially while communicating to the database the unique identifier identifying the personalized digital media.

In certain aspects, the method consists of sequential steps (a)-(h).

In certain aspects, the stored personalized digital media of step (a) is an electronic autograph, an electronic written message, an electronic video message, or a combination thereof provided by an author, a celebrity, an athlete, a musician, or a combination thereof.

In certain aspects, the stored personalized digital media of step (a) further includes a certificate of authenticity verifying authenticity of the stored personalized digital media of step (a).

In certain aspects, the certificate of authenticity includes a 95% confidence level associated with writing samples, voice recognition, facial recognition, or a combination thereof of the author, celebrity, athlete musician, or the combination thereof. While in further aspects, the certificate of authenticity includes a 99% confidence level associated with writing samples, voice recognition, facial recognition, or a combination thereof of the author, celebrity, athlete musician, or the combination thereof.

In certain aspects, the unique identifier is an embedded tag including at least one of a numerical identifier or a security feature. This numerical identifier or security feature may include metadata or boolean logic specifically identifying the personalized digital media including for example the time and date of creation of this digital media, the location and who created this digital media. In certain aspects, the unique identifier is a numerical identifier.

In certain aspects, the reward of step (f) includes a plurality of predetermined options from which the user selects a preferred reward from the plurality of predetermined options.

In certain aspects, the systems and methods further includes identifying the social media site of step (e) and offering varied, predetermined rewards during step (f), wherein the predetermined rewards are selectively associated with different electronic social media sites. In yet further aspects, the reward of step (f) includes a plurality of predetermined options from which the user selects a preferred reward from the plurality of predetermined options.

Also disclosed is a non-transitory computer readable medium embodying a program executable in a computing device for providing electronic rewards to a user based on identifying personalized digital media communicated to a social media site, the method including: (a) communicating a request from a user's media device to a database having stored personalized digital media; (b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site; (c) storing the communicated requested personalized digital media of step (b) on the user's media device; (d) accessing the electronic social media site with the user's media device; (e) communicating the personalized digital media of step (c) stored on the user's media device from the user's media device to the electronic social media site and sharing the personalized digital media on the electronic social media site such that other users of the social media site can view the personalized digital media; (0 after step (e), communicating in real time to the user's media device a reward for sharing the personalized digital media on the electronic social media site while concurrently communicating to the database the unique identifier identifying the personalized digital media; (g) after step (f), identifying, by the database, the personalized digital media of step (f) by the unique identifier and the electronic media site from which the personalized digital media of step (0 was communicated; and (h) determining a user's electronic social media habits by comparing the personalized digital media of step (g) with demographic information associated with the user's media device including at least one of age, education level, income, gender or any combination thereof.

In certain aspects, the non-transitory computer readable medium consists of sequential steps of (a)-(h).

In theory, social media sites should react differently depending on where a user chooses to display, for example, personalized digital media. By embedding the appropriate identifiers, personalized digital media can unlock a variety of different rewards and incentives that cater to the demographics that are most popular within a particular social media platform once the personalized digital media is posted and/or shared on a specific social media site In certain aspects, this could include the recipient's email address, which is often the unique identifier for logging into social media platforms like Facebook or Twitter. The personalized media includes the recipient's email address as part of a digital watermark, making each piece of signed media unique. The email address would be the first, and most common, unique identifier of each piece of media sent out and (ultimately) posted to a social media platform.

For instance, upon posting to Facebook, a personalized photo with an artist could ‘unlock’ different actions or allow certain gifts/rewards than the same autographed picture posted to Pinterest. These different rewards options help the artist identify and target various demographics of a worldwide fan base that is increasingly reliant on streaming media. The rewards and incentives can change based on the perceived differences in audience types and demographics. Rewards and incentives can be changed based on where/how the media is shared.

Social networks can also indicate preferred languages used by an artist's fans. While the autograph by an artist (i.e., personalized digital media) may be signed in English, if the autographed photo is then posted to a social media site in Portugese, Spanish, or Italian the entertainer can account for this after the fact. Future rewards can be customized to reflect the unique characteristics of each fan based on language, location, ethnicities, and/or other demographics revealed through the selected posting of personalized digital media.

The system can also offer fans within a specific demographic a plurality of options from which they may choose. For example, a fan (i.e., a user of the disclosed methods and systems) may be offered three different rewards options. If the fan is not interested in reward Option 1, say a $5 Starbucks card, they may choose instead reward Option 2, for instance a 10% discount on a band's current album. The fan can opt for this or go with (if available) Option 3, an article of clothing from a retailer featuring the artist's most recent tour. The system allows entertainers to personalize the loyalty program for long term fans by adjusting the rewards used in real time.

Repeated postings on the same or different social media networks can lead to additional or improved rewards as the fan becomes an active spokesperson for the entertainer. Such a system has broad utility for authors, musicians, actors, entertainers, and athletes—each of whom has a distinct need to find, cultivate, and retain a fan base over their professional careers, keeping rival entertainers from stealing away their audience and fan base.

Entertainers can build their global brand while still making their fan engagement feel local. For example, an entertainer could send autographed digital media to three different fans who attended (listened to) a streamed concert. A fan in China would receive a reward from Pepsi, a global sponsor of the artist. A fan in the U.S. might receive a coupon for discounted clothing the artists favors from a national retailer like Forever 21. Finally, a fan nearby the concert venue might receive a reward for a local burger joint that they could enjoy immediate after the concert is concluded. The autographed media adjusts automatically based on each fan's unique location, interests, or age as determined by how and where they display or use the autographed media. Other examples in which the systems and methods selectively determine rewards based on location and/or law specific rewards and incentives can include preventing a beer company from offering a reward in Russia, where the advertising of alcohol over the Internet is banned. Another example could be age related, where a movie studio would not want to promote an R-rated movie to young teenagers.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 depicts a reward or incentive program using a first social media site (e.g., social media site A).

FIG. 2 depicts a reward or incentive program from the same personalized media that changes because the fan uses a second social media site (e.g., social media site B);

FIG. 3 depicts giving a reward through a social media site by allowing the fan to select a reward from among several reward options; and

FIG. 4 depicts giving a reward or incentive that changes the offered options based on location, native language, or a combination thereof of the social media sites accordingly.

### DETAILED DESCRIPTION

The present invention will now be described more fully hereinafter with reference to the accompanying drawings in which exemplary embodiments of the invention are shown. In particular, the present invention is described below with reference to block diagrams and operational illustrations of methods, systems, and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently. The invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Generally, in terms of hardware architecture for the electronic devices disclosed below, computing device includes a processor, a memory, and one or more input and/or output (I/O) devices (or peripherals) that are communicatively coupled via a local interface. Local interface may be one or more buses or other wired or wireless connections, as is known in the art. Local interface may have additional elements, which are omitted for simplicity, such as controllers, buffers (caches), drivers, transmitters, and receivers to facilitate external communications with other like or dissimilar computing devices. Further, local interface may include address, control, and/or data connections to enable internal communications among the other computer components.

The processor is a hardware device for executing software, particularly software stored in memory. The processor can be any custom made or commercially available processor, such as, for example, a Core series or vPro processor made by Intel Corporation, or a Phenom, Athlon or Sempron processor made by Advanced Micro Devices, Inc. In the case where computing device is a server, the processor may be, for example, a Xeon or Itanium processor from Intel, or an Opteron-series processor from Advanced Micro Devices, Inc. Processor may also represent multiple parallel or distributed processors working in unison. Processor may also represent multiple processors located in a plurality of computing devices working in parallel, unison, or serial effort to achieve the disclosed methods.

Memory can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic magnetic, optical, and/or other types of storage media. Memory can have a distributed architecture where various components are situated remote from one another, but are still accessed by processor. These other components may reside on devices located elsewhere on a network or in a cloud arrangement.

The software in memory may include one or more separate programs. The separate programs comprise ordered listings of executable instructions for implementing logical functions. The software in memory may include the system in accordance with the invention, and a suitable operating system (O/S). Examples of suitable commercially available operating systems are Windows operating systems available from Microsoft Corporation, Mac OS X available from Apple Computer, Inc., a Unix operating system from AT&T, or a Unix-derivative such as BSD or Linux. The operating system O/S will depend on the type of computing device.

For example, if the computing device is a PDA or handheld computer (e.g., smartphone), the operating system may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system essentially controls the execution of other computer programs, such as the system, and provides scheduling, input-output control, file and data management, memory management, and communication control and related services.

If computing device is a PC compatible computer, Apple® computer, a handheld device, or the like, the software in memory may further include a basic input output system (BIOS). The BIOS is a set of essential software routines that initialize and test hardware at startup, start operating system, and support the transfer of data among the hardware devices. The BIOS is stored in ROM so that the BIOS can be executed when computing device is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, Swift, and Lua.

I/O device may include input devices such as a keyboard, a mouse, a scanner, a microphone, a touch screen, a bar code reader, or an infra-red reader. It may also include output devices such as a printer, a video display, an audio speaker or headphone port or a projector. I/O device may also comprise devices that communicate with inputs or outputs, such as a short-range transceiver (RFID, Bluetooth, etc.), a telephonic interface, a cellular communication port, a router, or other types of network communication equipment. I/O device may be internal to computing device, or may be external and connected wirelessly or via connection cable, such as through a universal serial bus port.

When the computing device is in operation, processor is configured to execute software stored within memory, to communicate data to and from memory, and to generally control operations of computing device pursuant to the software. The system and operating system, in whole or in part, may be read by processor, buffered within processor, and then executed.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would in46clude the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system can be embodied in any type of computer-readable medium for use by or in connection with an instruction execution system or apparatus, such as a computer.

For purposes of connecting to other computing devices, computing device is equipped with network communication equipment and circuitry. In a preferred embodiment, the network communication equipment includes a network card such as an Ethernet card, or a wireless connection card. In a preferred network environment, each of the plurality of computing devices on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks. In certain aspects, standalone systems not requiring connectivity to other systems are also contemplated.

In certain aspects and as further described below and depicted in the Figures, disclosed are a methods and systems of providing electronic rewards to a user based on identifying personalized digital media communicated to a social media site, the method comprising: (a) communicating a request from a user's media device to a database having stored personalized digital media; (b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site; (c) storing the communicated requested personalized digital media of step (b) on the user's media device; (d) accessing the electronic social media site with the user's media device; (e) communicating the personalized digital media of step (c) stored on the user's media device from the user's media device to the electronic social media site and sharing the personalized digital media on the electronic social media site such that other users of the social media site can view the personalized digital media; (f) after step (e), communicating in to the user's media device a reward for sharing the personalized digital media on the electronic social media site and also communicating to the database the unique identifier identifying the personalized digital media; (g) after step (f), identifying, by the database, the personalized digital media of step (f) by the unique identifier and the electronic media site from which the personalized digital media of step (f) was communicated; and (h) determining a user's electronic social media habits by comparing the personalized digital media of step (g) with demographic information associated with the user's media device comprising at least one of age, education level, income, gender or any combination thereof. In certain aspects, step (f) may be performed in real time and communicate the reward to the user's device either concurrently or sequentially while communicating to the database the unique identifier identifying the personalized digital media.

In certain aspects, the method consists of sequential steps (a)-(h).

In certain aspects, the stored personalized digital media of step (a) is an electronic autograph, an electronic written message, an electronic video message, or a combination thereof provided by an author, a celebrity, an athlete, a musician, or a combination thereof.

In certain aspects, the stored personalized digital media of step (a) further comprises a certificate of authenticity verifying authenticity of the stored personalized digital media of step (a).

In certain aspects, the certificate of authenticity comprises a 95% confidence level associated with writing samples, voice recognition, facial recognition, or a combination thereof of the author, celebrity, athlete musician, or the combination thereof. While in further aspects, the certificate of authenticity comprises a 99% confidence level associated with writing samples, voice recognition, facial recognition, or a combination thereof of the author, celebrity, athlete musician, or the combination thereof. In certain aspects, the certificate of authenticity verifying authenticity is a digital certificate generated by a scoring number associated with a media provider's (e.g., an author, celebrity, athlete, musician, or any combination thereof) signature (and/or writing samples), voice recognition, facial recognition, or a combination thereof. The media provider's autograph or electronic written message, for example, must achieve, for example, at least a 90% confidence level based on an X,Y array coordinates including a statistical comparison of velocity between coordinates and relative position of points between coordinates and the voice message, video message, or combination thereof, if present, must achieve at least a 90% confidence level based on amplitude and frequency and/or facial recognition when compared to reference samples of the media provider. Facial recognition can be calculated using a two dimensional mapping matrix comparing X,Y array coordinates of the media provider and comparing these values to a control, reference sample. In other aspects, the media provider's electronic signature or the electronic written message must achieve at least a 95% confidence level based on an X,Y array coordinates including a statistical comparison of velocity between coordinates and relative position of points between coordinates and the voice message, video message, or combination thereof, if present, must achieve at least a 95% confidence level based on amplitude and frequency and/or facial recognition when compared to reference samples of the media provider. In additional aspects, the electronic signature and the electronic written message must achieve at least a 99% confidence level based on an X,Y array coordinates including a statistical comparison of velocity between coordinates and relative position of points between coordinates and wherein at least one of the voice message, the video message, or a combination thereof and must achieve at least a 99% confidence level based on amplitude and frequency and/or facial recognition when compared to reference samples of the media provider.

In certain aspects, the unique identifier is an embedded tag comprising at least one of a numerical identifier or a security feature. This numerical identifier or security feature may include metadata or boolean logic specifically identifying the personalized digital media including for example the time and date of creation of this digital media, the location and who created this digital media. In certain aspects, the unique identifier is a numerical identifier.

In certain aspects, the reward of step (f) includes a plurality of predetermined options from which the user selects a preferred reward from the plurality of predetermined options.

In certain aspects, the systems and methods further comprise identifying the social media site of step (e) and offering varied, predetermined rewards during step (f), wherein the predetermined rewards are selectively associated with different electronic social media sites. In yet further aspects, the reward of step (f) includes a plurality of predetermined options from which the user selects a preferred reward from the plurality of predetermined options.

Also disclosed is a non-transitory computer readable medium embodying a program executable in a computing device for providing electronic rewards to a user based on identifying personalized digital media communicated to a social media site, the method comprising: (a) communicating a request from a user's media device to a database having stored personalized digital media; (b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site; (c) storing the communicated requested personalized digital media of step (b) on the user's media device; (d) accessing the electronic social media site with the user's media device; (e) communicating the personalized digital media of step (c) stored on the user's media device from the user's media device to the electronic social media site and sharing the personalized digital media on the electronic social media site such that other users of the social media site can view the personalized digital media; (f) after step (e), communicating in real time to the user's media device a reward for sharing the personalized digital media on the electronic social media site while concurrently communicating to the database the unique identifier identifying the personalized digital media; (g) after step (f), identifying, by the database, the personalized digital media of step (f) by the unique identifier and the electronic media site from which the personalized digital media of step (f) was communicated; and (h) determining a user's electronic social media habits by comparing the personalized digital media of step (g) with demographic information associated with the user's media device comprising at least one of age, education level, income, gender or any combination thereof.

In certain aspects, the non-transitory computer readable medium consists of sequential steps of (a)-(h).

In theory, social media sites and personalized media should react differently depending on where a fan chooses to display, for example, personalized digital media. By embedding the appropriate identifiers, personalized digital media can unlock a variety of different rewards and incentives that cater to the demographics that are most popular within a particular social media platform once the personalized digital media is posted and/or shared on a specific social media site.

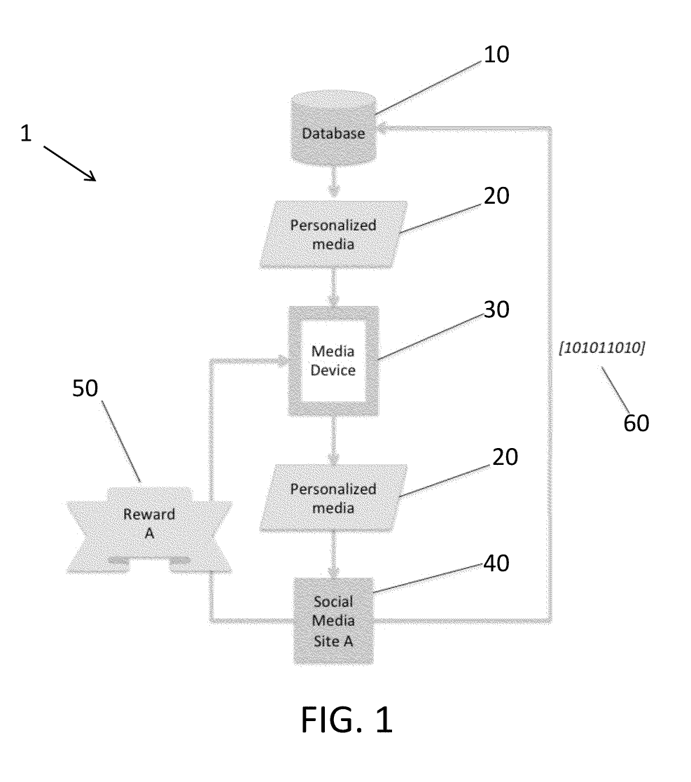

Now referring to FIGS. 1-4 and specifically referring to the system and method 1 of FIG. 1, an entertainer sends personalized digital memorabilia to a fan over a network with embedded reward or incentive data included. The reward or incentive can be customized (or restricted) based upon the social media site chosen. Specifically, a database component 10 sends the digital memorabilia over a network. The memorabilia 20 is delivered to the consumer's media device 30 where the digital memorabilia 20 can be viewed and enjoyed (photos, music, movies, etc). The personalized memorabilia 20 can also be subsequently shared on popular social media sites 40 where the embedded reward or incentive is activated and a notice delivered to the fan's media device 30. Based on the social media site used, the fan receives reward or incentive A 50.

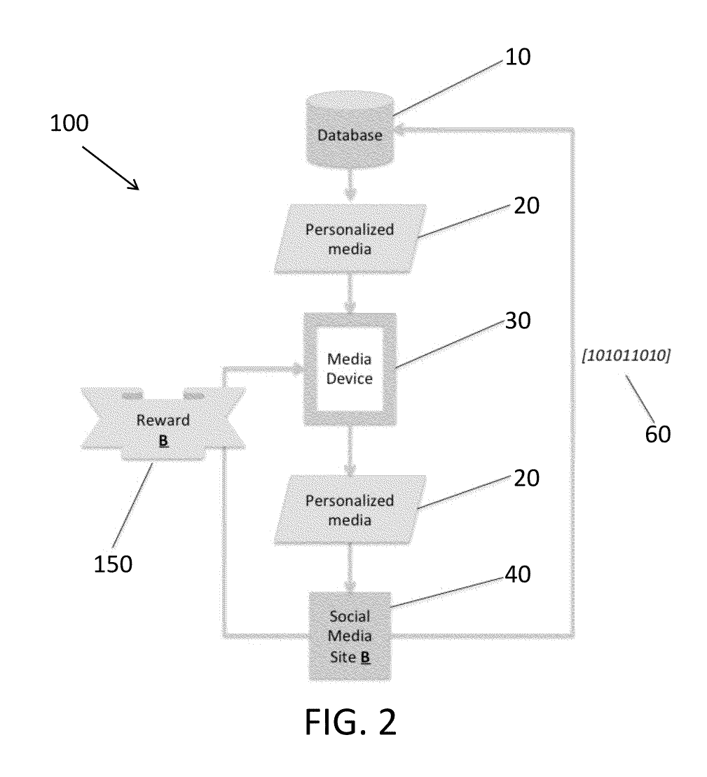

In certain aspects, referring to the system and method 100 of FIG. 2 and further comparing FIG. 2 to FIG. 1, an entertainer sends personalized digital memorabilia 20 to a fan over a network with embedded reward or incentive options included and is deliver to the consumer's media device 30. The personalized memorabilia 20 can also be shared on popular social media sites 40 where the embedded reward or incentive is activated and a notice delivered to the fan's media device 150. In view of the reward or incentive A 50 shown in FIG. 1, the reward or incentive 150 of FIG. 2 can be customized (or restricted) based upon the social media site chosen. If the fan posts the memorabilia to a different website, in certain aspects, the embedded reward or incentive changes.

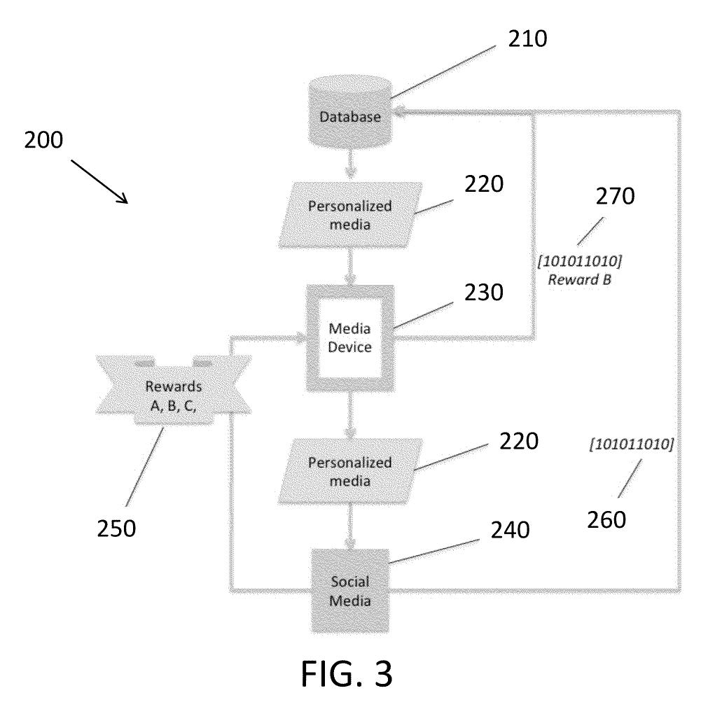

In certain aspects and referring to the system and method 200 of FIG. 3, an entertainer sends personalized digital memorabilia to a fan over a network with embedded reward or incentive data included. A plurality of optional rewards or incentives 250 from which the fan can select from is provided to allow the fan to further personalize the experience based on their own unique likes or preferences. The database component 210 of FIG. 3 sends the digital memorabilia 220 over a network. The memorabilia 220 is delivered to the consumer's media device 230 where the personalized digital memorabilia can be viewed and enjoyed (photos, music, movies, etc). The personalized digital memorabilia 220 can also be shared on popular social media sites 240 where a plurality of embedded rewards or incentives 250 are activated and a notice delivered to the fan's media device 230. Based on the fan's personal preferences, the fan can pick from among the plurality of options (A, B, C, etc.) 250 to choose from based on their specific likes, age appropriateness, age restrictions (alcohol for instance), or other control factors.

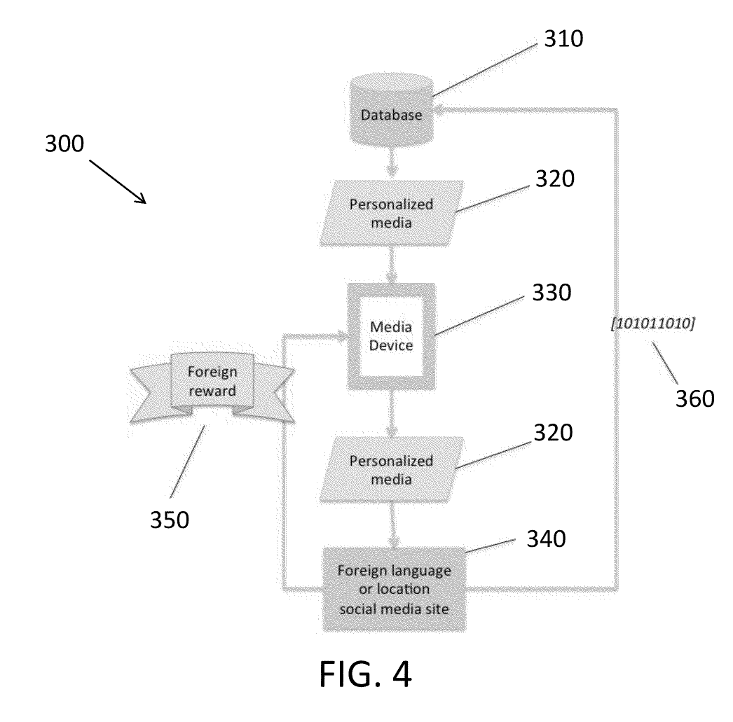

In certain aspects and referring to FIG. 4, the databased information on consumption is analyzed and provided to the artist. The database component 310 sends the digital memorabilia over a network. The memorabilia 320 is delivered to the consumer's media device 330 in a foreign country where the memorabilia 320 can be viewed and enjoyed (photos, music, movies, etc). The personalized memorabilia 320 can also be shared on popular social media sites 340 in another country. The embedded loyalty rewards 350 recognizes the change in location, language, or other factors and adjusts to the cultural, legal, or social norms of the media device's 330 location.

In each of the aspects provided above, identifiers 60, 260, 360 refer to, for example, registry code for the embedded reward or incentive that is sent to a database (the originating system or a stand-alone unit) to register the issuance of the reward or incentive and to further allow database 10, 210, 310 to determine which social media sites the user is visiting and posting on. These identifiers may be used to determine a user's electronic social media habits to further target user(s). In certain aspects, when referring to FIG. 3, an additional identifier 270, which may include additional registry code, is used to show a change to the originally intended reward or incentive that the fan has chosen. This will be updated in the database 210 (where the memorabilia originated or a second unit) so the fan's requested change is registered to one of the other options presented in the memorabilia.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of providing electronic rewards to a user based on identifying personalized digital media communicated to a social media site, the method comprising:
(a) communicating a request from a user's media device to a database having stored personalized digital media;
(b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site;
(c) storing the communicated requested personalized digital media of step (b) on the user's media device;
(d) accessing the electronic social media site with the user's media device;
(e) communicating the personalized digital media of step (c) stored on the user's media device from the user's media device to the electronic social media site and sharing the personalized digital media on the electronic social media site such that other users of the social media site can view the personalized digital media;
(f) after step (e), communicating in real time to the user's media device a reward for sharing the personalized digital media on the electronic social media site while concurrently communicating to the database the unique identifier identifying the personalized digital media;
(g) after step (f), identifying, by the database, the personalized digital media of step (f) by the unique identifier and the electronic media site from which the personalized digital media of step (0 was communicated; and
(h) determining a user's electronic social media habits by comparing the personalized digital media of step (g) with demographic information associated with the user's media device comprising at least one of age, education level, income, gender or any combination thereof.

2. The method of claim 1, wherein the method consists of sequential steps (a)-(h).

3. The method of claim 1, wherein the stored personalized digital media of step (a) is an electronic autograph, an electronic written message, an electronic video message, or a combination thereof provided by an author, a celebrity, an athlete, a musician, or a combination thereof.

4. The method of claim 3, wherein the stored personalized digital media of step (a) further comprises a certificate of authenticity verifying authenticity of the stored personalized digital media of step (a)

5. The method of claim 4, wherein the certificate of authenticity comprises a 95% confidence level associated with writing samples, voice recognition, facial recognition, or a combination thereof of the author, celebrity, athlete musician, or the combination thereof.

6. The method of claim 4, wherein the certificate of authenticity comprises a 99% confidence level associated with writing samples, voice recognition, facial recognition, or a combination thereof of the author, celebrity, athlete musician, or the combination thereof.

7. The method of claim 6, wherein the unique identifier is an embedded tag comprising at least one of a numerical identifier or a security feature.

8. The method of claim 6, wherein the unique identifier is a numerical identifier.

9. The method of claim 6, wherein the reward of step (f) includes a plurality of predetermined options from which the user selects a preferred reward from the plurality of predetermined options.

10. The method of claim 6, further comprising identifying the social media site of step (e) and offering varied, predetermined rewards during step (f), wherein the predetermined rewards are selectively associated with different electronic social media sites.

11. The method of claim 10, wherein the reward of step (f) includes a plurality of predetermined options from which the user selects a preferred reward from the plurality of predetermined options.

12. A non-transitory computer readable medium embodying a program executable in a computing device for providing electronic rewards to a user based on identifying personalized digital media communicated to a social media site comprising:
(a) communicating a request from a user's media device to a database having stored personalized digital media;
(b) processing, by the database, the request of step (a), the database subsequently communicating the requested personalized digital media to the user's media device, the requested personalized digital media having a unique identifier for subsequently identifying the personalized digital media once the personalized digital media is shared on an electronic social media site;
(c) storing the communicated requested personalized digital media of step (b) on the user's media device;
(d) accessing the electronic social media site with the user's media device;
(e) communicating the personalized digital media of step (c) stored on the user's media device from the user's media device to the electronic social media site and sharing the personalized digital media on the electronic social media site such that other users of the social media site can view the personalized digital media;
(f) after step (e), communicating in real time to the user's media device a reward for sharing the personalized digital media on the electronic social media site while concurrently communicating to the database the unique identifier identifying the personalized digital media;
(g) after step (0, identifying, by the database, the personalized digital media of step (f) by the unique identifier and the electronic media site from which the personalized digital media of step (f) was communicated; and
(h) determining a user's electronic social media habits by comparing the personalized digital media of step (g) with demographic information associated with the user's media device comprising at least one of age, education level, income, gender or any combination thereof.

13. The non-transitory computer readable medium of claim 12, wherein the non-transitory computer readable medium consists of sequential steps of (a)-(h).
